(19) United States
(12) Patent Application Publication
(10) Pub. No.: US 2024/0288333 A1
(43) Pub. Date: Aug. 29, 2024

(54) LEAK INSPECTION APPARATUS AND LEAK INSPECTION METHOD

(71) Applicant: Honda Motor Co., Ltd., Tokyo (JP)

(72) Inventors: Satoshi Hasegawa, Tokyo (JP); Yoshihiro Yamashita, Saitama (JP)

(21) Appl. No.: 18/444,953

(22) Filed: Feb. 19, 2024

(30) Foreign Application Priority Data
Feb. 24, 2023 (JP) 2023-027124

(51) Int. Cl. G01M 3/32; H01M 8/0438; H01M 8/04664; H01M 8/10

(52) U.S. Cl. CPC G01M 3/3254; H01M 8/04388; H01M 8/04395; H01M 8/04664; H01M 2008/1095

(57) ABSTRACT

Leak-inspection-apparatus inspecting leakage-state of product including first/second-paths. First/second-paths are separated from external-space through first-member and separated from each other through second-member. Leak-inspection-apparatus includes: gas-supply-unit supplying gas to first-path at first-pressure and second-path at second-pressure lower than first-pressure; flowmeters measuring flow rates of gas from first/second-path; and computer. Computer: performs first-determination to determine leakage of gas from first/second-path to external-space based on flow rates measured in first-period after gas supply; and performs second-determination to determine leakage of gas from first-path to second-path based on flow rates measured in second-period after first-period. In first-determination, computer determines that there is defect in first-member when leakage is determined, while determines that there is no defect in first-member when no leakage is determined. In second-determination, computer determines that there is defect in second-member when leakage is determined, while determines that there is no defect in second-member when no leakage is determined.

### CROSS-REFERENCE TO RELATED APPLICATION

This application is based upon and claims the benefit of priority from Japanese Patent Application No. 2023-027124 filed on Feb. 24, 2023, the content of which is incorporated herein by reference.

### BACKGROUND OF THE INVENTION

### Field of the Invention

This invention relates to a leak inspection apparatus and a leak inspection method configured to inspect leakage state of a product having a plurality of flow paths.

### Description of the Related Art

In the related art, a device configured to inspect a leakage state of a fuel cell stack has been known (for example, see JP 2020-159935 A). In the device described in JP 2020-159935 A, a fuel gas is introduced into an anode flow path of the fuel cell stack, and when the amount of gas flowing out to an outside of the fuel cell stack per unit time after a lapse of a predetermined time is equal to or less than a predetermined value, it is determined that the fuel gas is in a permeation state of permeating a sealant, and when the amount of gas is more than the predetermined value, it is determined that the fuel gas is in the leak state of leaking from a gap.

Since a product such as the fuel cell stack or the power generation cell has a plurality of flow paths such as an anode flow path, a cathode flow path, and a cooling flow path, leakage states of the plurality of flow paths are preferably inspected. However, the device described in JP 2020-159935 A only inspects a leakage state of a single channel, and it is difficult to efficiently inspect the leakage states of the plurality of flow paths.

### SUMMARY OF THE INVENTION

An aspect of the present invention is a leak inspection apparatus configured to inspect a leakage state of a product including a first flow path and a second flow path. The first flow path and the second flow path are separated from an external space through a first intermediate member respectively and are separated from each other through a second intermediate member. The leak inspection apparatus includes: a gas supply unit configured to supply inspection gas to the first flow path at a first pressure and supply the inspection gas to the second flow path at a second pressure lower than the first pressure; flowmeters configured to measure flow rates of the inspection gas flowing out from each of the first flow path and the second flow path; and a computer including a processor and a memory coupled to the processor. The computer: performs a first determination to determine whether there is leakage of the inspection gas from each of the first flow path and the second flow path to the external space based on the flow rates measured by the flowmeters in a first period after supply of the inspection gas; and performs a second determination to determine whether there is leakage of the inspection gas from the first flow path to the second flow path based on the flow rates measured by the flowmeters in a second period after the first period. In the first determination, the computer determines that there is a defect in the first intermediate member when it is determined that there is leakage of the inspection gas to the external space in the first period, while determines that there is no defect in the first intermediate member when it is determined that there is no leakage of the inspection gas to the external space in the first period. In the second determination, the computer determines that there is a defect in the second intermediate member when it is determined that there is leakage of the inspection gas from the first flow path to the second flow path in the second period, while determines that there is no defect in the second intermediate member when it is determined that there is no leakage of the inspection gas from the first flow path to the second flow path in the second period.

Another aspect of the present invention is a leak inspection method configured to inspect a leakage state of a product including a first flow path and a second flow path. The first flow path and the second flow path are separated from an external space through a first intermediate member respectively and are separated from each other through a second intermediate member. The leak inspection method includes the steps of: supplying inspection gas to the first flow path at a first pressure and supply the inspection gas to the second flow path at a second pressure lower than the first pressure; measuring flow rates of the inspection gas flowing out from each of the first flow path and the second flow path; performing a first determination to determine whether there is leakage of the inspection gas from each of the first flow path and the second flow path to the external space based on the flow rates measured in a first period after supply of the inspection gas; and performing a second determination to determine whether there is leakage of the inspection gas from the first flow path to the second flow path based on the flow rates measured in a second period after the first period. In the first determination, it is determined that there is a defect in the first intermediate member when it is determined that there is leakage of the inspection gas to the external space in the first period, while it is determined that there is no defect in the first intermediate member when it is determined that there is no leakage of the inspection gas to the external space in the first period. In the second determination, it is determined that there is a defect in the second intermediate member when it is determined that there is leakage of the inspection gas from the first flow path to the second flow path in the second period, while it is determined that there is no defect in the second intermediate member when it is determined that there is no leakage of the inspection gas from the first flow path to the second flow path in the second period.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack to which a leak inspection apparatus according to an embodiment of the present invention is applied;

FIG. 2 is a perspective view illustrating a schematic configuration of an electrode assembly included in the fuel cell stack of FIG. 1;

FIG. 3 is a partial cross-sectional view showing an example of a configuration near an upper end portion of a power generation cell of FIG. 1;

FIG. 4A is a front view of a separator showing a disposition example of welding lines of FIG. 3 as viewed from a rear side;

FIG. 4B is a front view of the separator showing a disposition example of seal lines of FIG. 3 as viewed from a rear side;

FIG. 4C is a front view of the separator showing a disposition example of the seal lines of FIG. 3 as viewed from a front side;

FIG. 5 is a conceptual diagram for describing a relationship among an anode flow path, a cathode flow path, a cooling flow path, and an external space of FIG. 3;

FIG. 6 is a block diagram schematically illustrating an example of a configuration of main components of the leak inspection apparatus according to the embodiment of the present invention;

FIG. 7 is a diagram for describing determination of leakage states by a controller of FIG. 6; and

FIG. 8 is a flow chart illustrating an example of processing performed by the leak inspection apparatus according to the embodiment of the present invention.

### DETAILED DESCRIPTION OF THE INVENTION

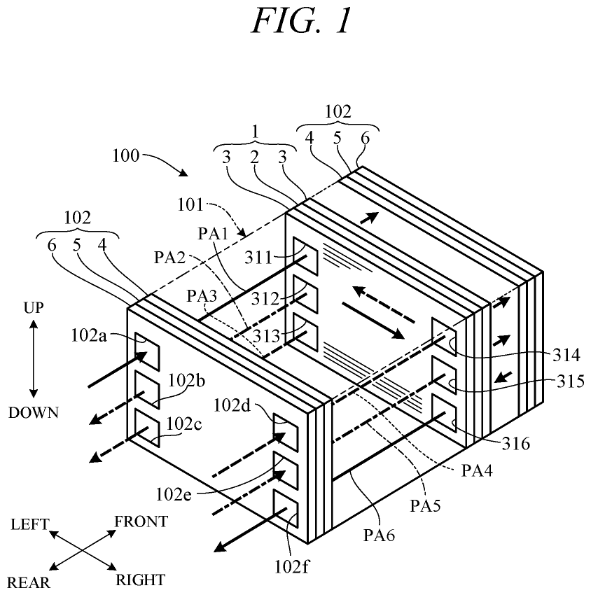

Hereinafter, embodiments of the present invention will be described with reference to FIGS. 1 to 8. A leak inspection apparatus according to the embodiment of the present invention is applied to leak inspection of a product having a plurality of flow paths, and particularly applied to leak inspection of an anode flow path, a cathode flow path, and a cooling flow path of a fuel cell stack or a power generation cell. The fuel cell stack is a component of a fuel cell, and the power generation cell is a component of the fuel cell stack. The fuel cell is mounted on, for example, a vehicle and can generate electric power for driving the vehicle. First, an overall configuration of the fuel cell stack will be schematically described.

FIG. 1 is a perspective view schematically showing an overall configuration of a fuel cell stack 100 to which the leak inspection apparatus according to the embodiment of the present invention is applied. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions are not necessarily identical to a front-rear direction, a left-right direction, and an up-down direction of the vehicle. For example, the front-rear direction in FIG. 1 may be the front-rear direction, the left-right direction, or the up-down direction of the vehicle.

As illustrated in FIG. 1, the fuel cell stack 100 includes a cell stacked body 101 formed by stacking a plurality of power generation cells 1 in the front-rear direction, and end units 102 disposed at both front and rear ends of the cell stacked body 101, and has a substantially rectangular parallelepiped shape as a whole. A length of the cell stacked body 101 in the left-right direction is longer than a length in the up-down direction. In FIG. 1, a single power generation cell 1 is shown for the sake of convenience. The power generation cell 1 includes an electrode assembly 2 having a joint body including an electrolyte membrane and an electrode, and separators 3 and 3 that are disposed on both front and rear sides of the electrode assembly 2 and sandwich the electrode assembly 2. The electrode assembly 2 and the separators 3 are alternately disposed in the front-rear direction.

The separator 3 includes a pair of front and rear metal thin plates having a corrugated cross section, and is integrally formed by joining outer peripheries of the thin plates. For the separator 3, a conductive material having excellent corrosion resistance is used, and for example, titanium, a titanium alloy, stainless steel, or the like can be used. A cooling flow path through which a cooling medium flows is formed inside the separator 3 by press-molding or the like, and a power generation surface of the power generation cell 1 is cooled by the flow of the cooling medium. For example, water can be used as the cooling medium. Surfaces (front surface and rear surface) of the separators 3 facing the electrode assembly 2 are formed in an uneven shape to form gas flow paths between the separators and the joint body of the electrode assembly 2.

The front separator 3 of the electrode assembly 2 is, for example, a separator on an anode side (anode separator), and an anode flow path through which a fuel gas flows is formed between the anode separator 3 and the joint body of the electrode assembly 2. The rear separator 3 of the electrode assembly 2 is, for example, a separator on a cathode side (cathode separator), and a cathode flow path through which an oxidant gas flows is formed between the cathode separator 3 and the joint body of the electrode assembly 2. For example, a hydrogen gas can be used as the fuel gas, and for example, air can be used as the oxidant gas. The fuel gas and the oxidant gas may be referred to as a reaction gas without being distinguished from each other.

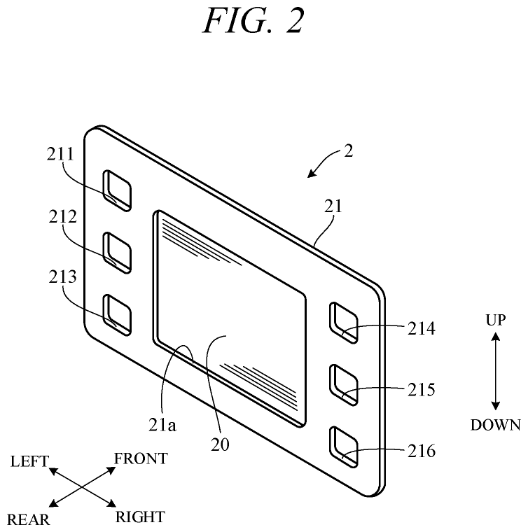

FIG. 2 is a perspective view illustrating a schematic configuration of the electrode assembly 2. As illustrated in FIG. 2, the electrode assembly 2 includes a substantially rectangular joint body 20 and a frame 21 that supports the joint body 20. The joint body 20 is a membrane electrode joint body (so-called Membrane Electrode Assembly or MEA), and has an electrolyte membrane, an anode electrode provided on a front surface of the electrolyte membrane, and a cathode electrode provided on a rear surface of the electrolyte membrane.

The electrolyte membrane is, for example, a solid polymer electrolyte membrane, and a thin film of perfluorosulfonic acid containing moisture can be used. Not only a fluorine-based electrolyte but also a hydrocarbon-based electrolyte can be used.

The anode electrode has a catalyst layer formed on the front surface of the electrolyte membrane and a gas diffusion layer formed on a front surface of the catalyst layer. The cathode electrode has a catalyst layer formed on the rear surface of the electrolyte membrane and a gas diffusion layer formed on a rear surface of the catalyst layer. The catalyst layer of each electrode includes a catalytic metal that promotes an electrochemical reaction between hydrogen contained in the fuel gas and oxygen contained in the oxidant gas, an electrolyte having proton conductivity, carbon particles having electron conductivity, and the like. The gas diffusion layer of each electrode is made of a conductive member having gas permeability, for example, a carbon porous body.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied through the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the electrode assembly 2.

The frame 21 is a thin plate having a substantially rectangular shape, and is made of an insulating resin, rubber, or the like. A substantially rectangular opening 21a is provided in a central portion of the frame 21, and the joint body 20 is provided to cover the entire opening 21a. Three through-holes 211 to 213 penetrating the frame 21 in the front-rear direction are opened side by side in the up-down direction on a left side of the opening 21a of the frame 21, and three through-holes 214 to 216 penetrating the frame 21 in the front-rear direction are opened side by side in the up-down direction on a right side of the opening 21a.

As shown in FIG. 1, through-holes 311 to 316 penetrating the separators 3 in the front-rear direction are opened in the front and rear separators 3 of the electrode assembly 2 at positions corresponding to the through-holes 211 to 216 of the frame 21. The through-holes 311 to 316 communicate with the through-holes 211 to 216 of the frame 21. The set of the through-holes 211 to 216 and 311 to 316 communicating with each other forms flow paths PA1 to PA6 (indicated by arrows for the sake of convenience) penetrating the cell stacked body 101 and extending in the front-rear direction. The flow paths PA1 to PA6 may be referred to as manifolds (discharge manifolds). The flow paths PA1 to PA6 are connected to a manifold outside the fuel cell stack 100.

The flow path PA1 (solid arrow) extending forward via the through-holes 211 and 311 is a fuel gas supply flow path. The flow path PA6 (solid arrow) extending rearward via the through-holes 216 and 316 is a fuel gas discharge flow path. The fuel gas supply flow path PA1 and the fuel gas discharge flow path PA6 communicate with the anode flow path facing a front surface of the joint body 20, and as indicated by the solid arrows, the fuel gas flows through the anode flow path in the left-right direction via the fuel gas supply flow path PA1 and the fuel gas discharge flow path PA6. The fuel gas flowing through the fuel gas discharge flow path PA6 is a fuel gas a part of which has been used in the anode electrode, and may be referred to as a fuel exhaust gas.

The flow path PA4 (dotted arrow) extending forward via the through-holes 214 and 314 is an oxidant gas supply flow path. The flow path PA3 (dotted arrow) extending rearward via the through-holes 213 and 313 is an oxidant gas discharge flow path. The oxidant gas supply flow path PA4 and the oxidant gas discharge flow path PA3 communicate with the cathode flow path facing a rear surface of the joint body 20, and as indicated by the dotted arrows, the oxidant gas flows through the cathode flow path in the left-right direction via the oxidant gas supply flow path PA4 and the oxidant gas discharge flow path PA3. The oxidant gas flowing through the oxidant gas discharge flow path PA3 is an oxidant gas a part of which has been used in the cathode electrode, and may be referred to as oxidant exhaust gas. The fuel exhaust gas and the oxidant exhaust gas may be referred to as a reaction exhaust gas without being distinguished from each other.

The flow path PA5 (dashed-dotted line arrow) extending forward via the through-holes 215 and 315 is a cooling medium supply flow path. The flow path PA2 (dashed-dotted line arrow) extending rearward via the through-holes 212 and 312 is a cooling medium discharge flow path. The cooling medium supply flow path PA5 and the cooling medium discharge flow path PA2 communicate with the cooling flow path inside the separator 3, and the cooling medium flows through the cooling flow path via the cooling medium supply flow path PA5 and the cooling medium discharge flow path PA2.

Each of the end units 102 disposed on both the front and rear sides of the cell stacked body 101 includes a terminal plate 4, an insulating plate 5, and an end plate 6. Note that, the front end unit 102 may be referred to as a dry-side end unit, and the rear end unit 102 may be referred to as a wet-side end unit. The pair of front and rear terminal plates 4 and 4 is disposed on both front and rear sides of the cell stacked body 101 with the cell stacked body interposed therebetween. The pair of front and rear insulating plates 5 and 5 is disposed on both front and rear sides of the terminal plates 4 and 4. The pair of front and rear end plates 6 and 6 is disposed on both front and rear sides of the insulating plates 5 and 5.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength, and for example, a coupling member having a small length in the front-rear direction and coupling the front and rear end plates 6 and 6 to each other is fixed to the end plate 6 with a bolt. The fuel cell stack 100 is held in a state of being pressed in the front-rear direction by the end plates 6 and 6 via the coupling member.

A plurality of through-holes 102a to 102f penetrating the end unit 102 in the front-rear direction are opened in the rear end unit 102. Note that, the through-holes 102a to 102f include a through-hole penetrating the terminal plate 4, a through-hole penetrating the insulating plate 5, and a through-hole penetrating the end plate 6. In FIG. 1, these through-holes are collectively referred to as through-holes 102a to 102f for the sake of convenience. The through-hole 102a is opened on an extension line of the fuel gas supply flow path PA1 to communicate with the fuel gas supply flow path PA1. The through-hole 102b is opened on an extension line of the cooling medium discharge flow path PA2 to communicate with the cooling medium discharge flow path PA2. The through-hole 102c is opened on an extension line of the oxidant gas discharge flow path PA3 to communicate with the oxidant gas discharge flow path PA3. The through-hole 102d is opened on an extension line of the oxidant gas supply flow path PA4 to communicate with the oxidant gas supply flow path PA4. The through-hole 102e is opened on an extension line of the cooling medium supply flow path PA5 to communicate with the cooling medium supply flow path PA5. The through-hole 102f is opened on an extension line of the fuel gas discharge flow path PA6 to communicate with the fuel gas discharge flow path PA6.

More specifically, a fuel gas tank storing a high-pressure fuel gas is connected to the through-hole 102a via an ejector, an injector, or the like, and the fuel gas in the fuel gas tank is supplied to the fuel cell stack 100 via the through-hole 102a. A gas-liquid separator is connected to the through-hole 102f, and a fuel gas (fuel exhaust gas) discharged via the through-hole 102f is separated into a fuel gas and water by the gas-liquid separator. The separated fuel gas is sucked via the ejector and is supplied to fuel cell stack 100 again. The separated water is discharged to an outside via a drain flow path.

A compressor for supplying the oxidant gas is connected to the through-hole 102d, and the oxidant gas compressed by the compressor is supplied to fuel cell stack 100 via the through-hole 102d. The oxidant gas (oxidant exhaust gas) flows to an outside from the through-hole 102c. A pump for supplying the cooling medium is connected to the through-hole 102e, and the cooling medium is supplied to the fuel cell stack 100 via the through-hole 102e. The cooling medium is discharged from the through-hole 102b. The discharged cooling medium is cooled by heat exchange in a radiator, and is supplied to the fuel cell stack 100 again via the through-hole 102e.

A schematic configuration of the fuel cell stack 100 has been described above. The fuel cell stack 100 is housed in a substantially box-shaped case and is mounted on the vehicle.

It is necessary to check the soundness of the fuel cell stack 100 and the power generation cell 1 in the mounting on the vehicle before the fuel cell stack and the power generation cell are actually used as products. In this case, the soundness of the fuel cell stack 100 including the members constituting the flow paths and the whole power generation cell 1 can be checked by inspecting a leakage state of each of the anode flow path, the cathode flow path, and the cooling flow path and checking the soundness of each flow path. The members constituting the flow paths and representative defects thereof will be described.

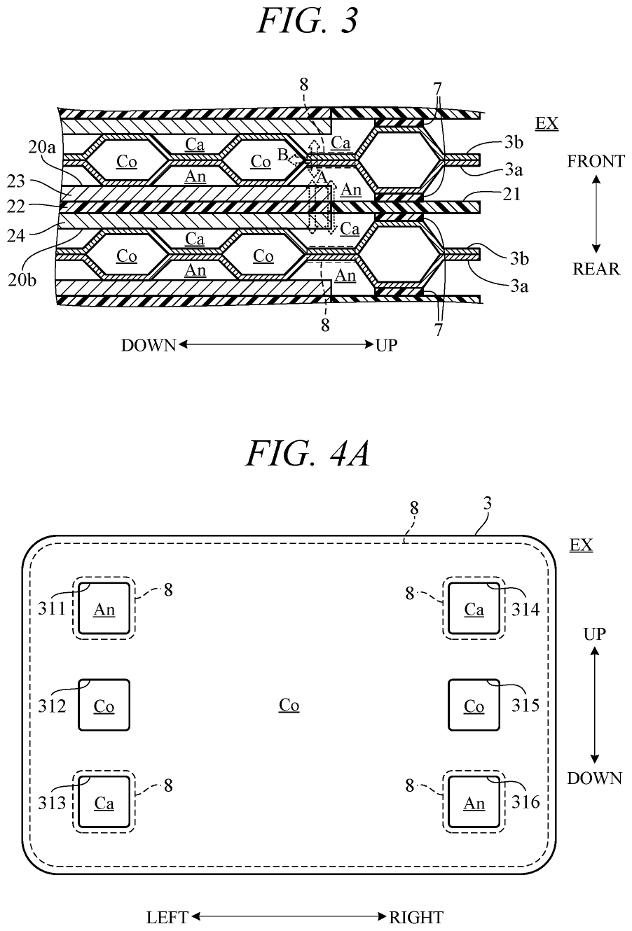

FIG. 3 is a partial cross-sectional view showing an example of a configuration near an upper end portion of the power generation cell 1. As illustrated in FIG. 3, the joint body 20 of the electrode assembly 2 includes an electrolyte membrane 22, an anode electrode 23 provided on a front surface of the electrolyte membrane 22, and a cathode electrode 24 provided on a rear surface of the electrolyte membrane 22. The front surface of the joint body 20, that is, a surface of the anode electrode 23 constitutes an anode surface 20a of the joint body 20. The rear surface of the joint body 20, that is, a surface of the cathode electrode 24 constitutes a cathode surface 20b of the joint body 20. The separator 3 has a pair of front and rear thin plates 3a and 3b.

Anode flow paths An through which the fuel gas flows are formed between the rear thin plate 3a of the front anode separator 3 of the electrode assembly 2 and the anode surface 20a of the joint body 20. Cathode flow paths Ca through which the oxidant gas flows are formed between the front thin plate 3b of the rear cathode separator 3 of the electrode assembly 2 and the cathode surface 20b of the joint body 20. A cooling flow path Co through which the cooling medium flows is formed between the pair of front and rear thin plates 3a and 3b of the separator 3.

The anode flow path An and the cathode flow path Ca are separated from each other via the joint body 20 of the electrode assembly 2 and the separator 3. The electrolyte membrane 22 of the joint body 20 is made of a material having gas permeability such as a solid polymer electrolyte membrane, and allows a gas to permeate therethrough with a predetermined permeability coefficient. The separator 3 is made of metal and has no gas permeability. Since the electrolyte membrane 22 is extremely thin, cracks caused on the surface or inside thereof may develop to cause breakage (defect). Alternatively, a gap (defect) may be formed between the electrolyte membrane 22 and the frame 21. In this case, as indicated by an arrow A in FIG. 3, the anode flow path An and the cathode flow path Ca communicate with each other.

On an upper end side of the anode flow paths An and the cathode flow paths Ca, seal lines 7 formed by using a seal member such as resin or rubber are provided between the frame 21 of the electrode assembly 2 and the separators 3. The anode flow path An and the cathode flow path Ca are separated from an external space EX through the seal lines 7. On an upper end side of the cooling flow paths Co, welding lines 8 which are welded portions for joining the pairs of front and rear thin plates 3a and 3b of the separators 3 are provided. The cooling flow paths Co are separated from the external space EX through the welding line 8.

In the welding line 8, when there is even a slight space between the pair of front and rear thin plates 3a and 3b at the welded portion, air or the like in the space is thermally expanded due to a high temperature at the time of welding, and thus, breakage (defect) may be caused in the separator 3 at the welded portion. In this case, as indicated by an arrow B in FIG. 3, the anode flow path An and the cathode flow path Ca communicate with the cooling flow path Co.

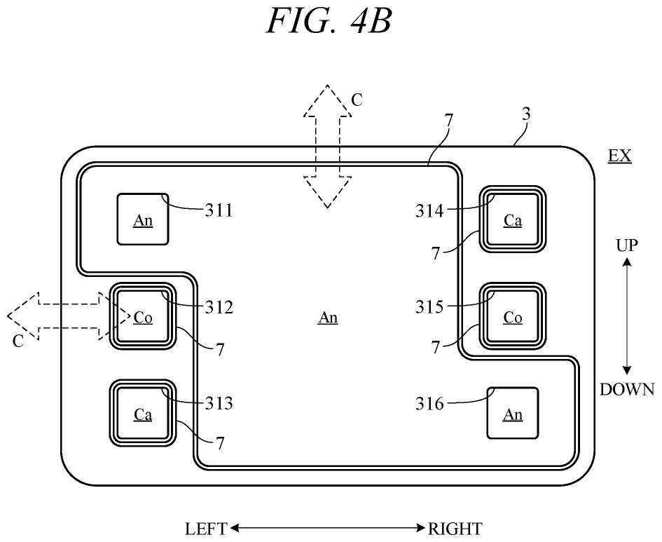

FIG. 4A is a front view of the separator 3 showing a disposition example of the welding lines 8 as viewed from a rear side, and shows the welded portion of the pair of front and rear thin plates 3a and 3b of the separator 3. As shown in FIG. 4A, the welding lines 8 are provided to surround all the cooling flow paths Co formed between the thin plates 3a and 3b, and thus, the cooling flow paths Co are separated from the external space EX. In addition, the welding lines 8 are provided to surround the through-hole 311 (fuel gas supply flow path PA1) and the through-hole 316 (fuel gas discharge flow path PA6), and thus, the cooling flow paths Co and the anode flow paths An are separated. Further, the welding lines 8 are provided to surround the through-hole 314 (oxidant gas supply flow path PA4) and the through-hole 313 (oxidant gas discharge flow path PA3), and thus, the cooling flow paths Co and the cathode flow paths Ca are separated.

FIG. 4B is a front view of the separator 3 showing a disposition example of the seal lines 7 as viewed from a rear side, and shows a surface of the separator 3 (thin plate 3a) facing the anode flow paths An. As shown in FIG. 4B, the seal lines 7 are provided to surround all the anode flow paths An including the through-hole 311 (fuel gas supply flow path PA1) and the through-hole 316 (fuel gas discharge flow path PA6), and thus, the anode flow paths An and the external space EX are separated from each other. In addition, the seal lines 7 are provided to surround the through-hole 314 (oxidant gas supply flow path PA4) and the through-hole 313 (oxidant gas discharge flow path PA3), and thus, the cathode flow paths Ca and the external space EX are separated from each other. Further, the seal lines 7 are provided to surround the through-hole 312 (cooling medium discharge flow path PA2) and the through-hole 315 (cooling medium supply flow path PA5), and thus, the cooling flow path Co and the external space EX are separated from each other.

FIG. 4C is a front view of the separator 3 showing a disposition example of the seal lines 7 as viewed from a front side, and shows a surface of the separator 3 (thin plate 3b) facing the cathode flow paths Ca. As shown in FIG. 4C, the seal lines 7 are provided to surround all the cathode flow paths Ca including the through-hole 314 (oxidant gas supply flow path PA4) and the through-hole 313 (oxidant gas discharge flow path PA3), and thus, the cathode flow path Ca and the external space EX are separated from each other. In addition, the seal lines 7 are provided to surround the through-hole 311 (fuel gas supply flow path PA1) and the through-hole 316 (fuel gas discharge flow path PA6), and thus, the anode flow path An and the external space EX are separated from each other. Further, the seal lines 7 are provided to surround the through-hole 312 (cooling medium discharge flow path PA2) and the through-hole 315 (cooling medium supply flow path PA5), and thus, the cooling flow path Co and the external space EX are separated from each other.

The seal line 7 is made of a material having gas permeability such as resin or rubber, and allows a gas to permeate therethrough at a predetermined permeability coefficient different from the permeability coefficient of the electrolyte membrane 22. Since the frame 21 of the electrode assembly 2 and the separator 3 have flexibility, a gap (defect) may be formed between the seal line 7 illustrated in FIG. 3 and the frame 21 of the electrode assembly 2 near the center in the extending direction (the left-right direction or the up-down direction). In this case, as indicated by arrows C in FIGS. 3, 4B, and 4C, the anode flow paths An and the external space EX, the cathode flow paths Ca and the external space EX, or the cooling flow paths Co and the external space EX communicate with each other.

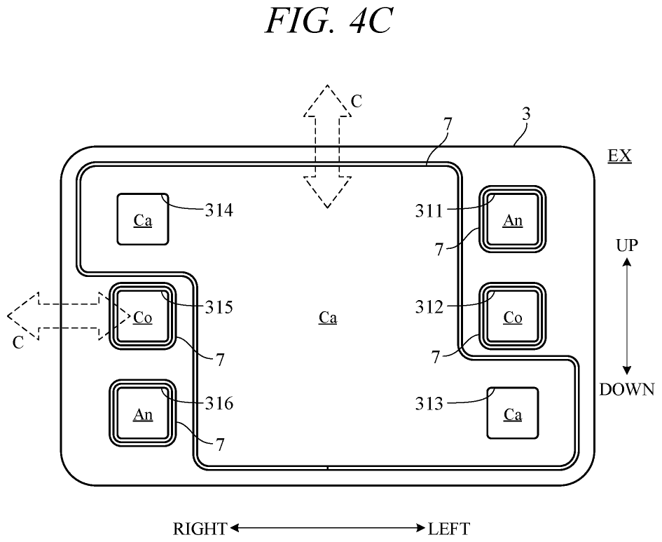

FIG. 5 is a conceptual diagram for describing a relationship among the anode flow path An, the cathode flow path Ca, the cooling flow path Co, and the external space EX. The anode flow path An and the cathode flow path Ca are separated from each other through the electrode assembly 2 including the electrolyte membrane 22. When there is no defect in the electrode assembly 2 (on the periphery of the electrolyte membrane 22), gas permeates between the anode flow path An and the cathode flow path Ca in accordance with a differential pressure and a permeability coefficient of the electrolyte membrane 22 (dotted arrow). When there is a defect in the electrode assembly 2 (on the periphery of the electrolyte membrane 22), the anode flow path An and the cathode flow path Ca communicate with each other, and the gas moves in accordance with the differential pressure (arrow A).

Each of the anode flow path An and the cathode flow path Ca and the cooling flow path Co are separated from each other through the separator 3 including the welding lines 8. Since the separator 3 is made of metal and does not have gas permeability, when there is no defect in the separator 3 (welding line 8), gas does not move between each of the anode flow path An and the cathode flow path Ca and the cooling flow path Co. When there is a defect in the separator 3 (welding line 8), the anode flow path An and the cathode flow path Ca communicate with the cooling flow path Co, and the gas moves in accordance with the differential pressure (arrow B).

The anode flow path An, the cathode flow path Ca, and the cooling flow path Co are separated from the external space EX through the seal lines 7. When there is no defect in the seal line 7 (periphery), gas permeates between the anode flow path An and the external space EX, between the cathode flow path Ca and the external space EX, or between the cooling flow path Co and the external space EX in accordance with a differential pressure and a permeability coefficient of the seal member constituting the seal line 7 (dotted arrow). When there is a defect in the seal line 7 (periphery), the anode flow path An and the external space EX, the cathode flow path Ca and the external space EX, or the cooling flow path Co and the external space EX communicate with each other, and the gas moves in accordance with the differential pressure (arrow C).

Accordingly, the leakage state of each of the anode flow path An, the cathode flow path Ca, and the cooling flow path Co is inspected. As a result, the soundness of the fuel cell stack 100 and the power generation cell 1 can be checked, and the defective portion can be identified. In the present embodiment, the leak inspection apparatus is configured as follows such that the leak state from each of the plurality of flow paths of the fuel cell stack 100 and the power generation cell 1 can be efficiently inspected.

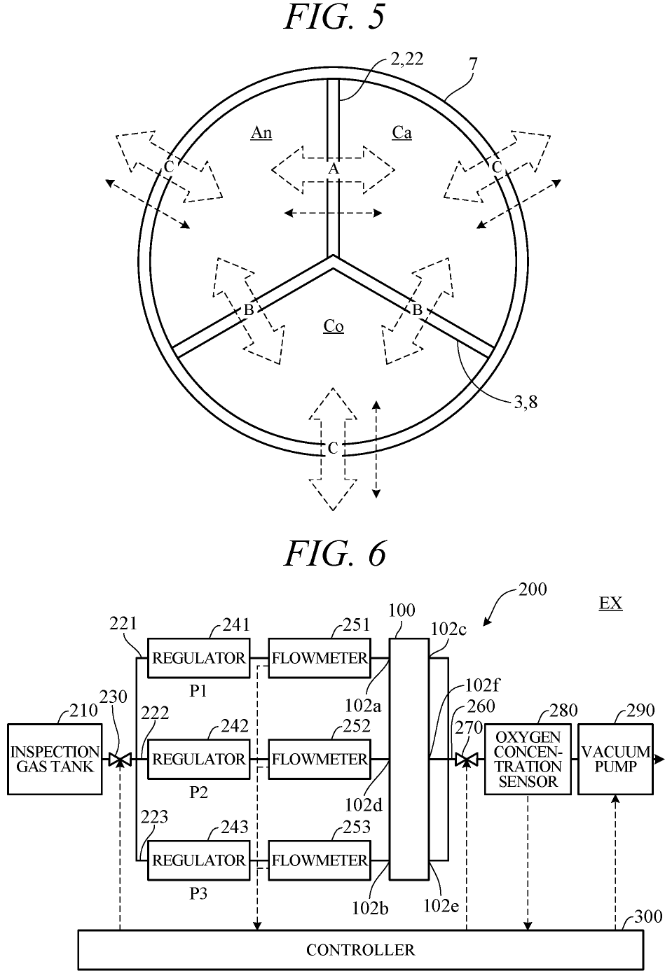

FIG. 6 is a block diagram schematically illustrating an example of a configuration of main components of a leak inspection apparatus (hereinafter, an apparatus) 200 according to the embodiment of the present invention. As shown in FIG. 6, the apparatus 200 includes an inspection gas tank 210 in which a high-pressure inspection gas is stored, supply lines 221 to 223 that connect the inspection gas tank 210 and the through-holes 102a, 102d, and 102e respectively communicating with the anode flow path An, the cathode flow path Ca, and the cooling flow path Co of the fuel cell stack 100, an on-off valve 230 that opens and closes the supply lines 221 to 223, and regulators 241 to 243 and flowmeters 251 to 253 respectively provided in the supply lines 221 to 223. The inspection gas tank 210 and the regulators 241 to 243 constitute a gas supply unit.

The apparatus 200 further includes a discharge line 260 connected to the through-holes 102f, 102c, and 102b respectively communicating with the anode flow path An, the cathode flow path Ca, and the cooling flow path Co of the fuel cell stack 100, an on-off valve 270 that opens and closes the discharge line 260, and an oxygen concentration sensor 280 and a vacuum pump 290 provided in the discharge line 260. The apparatus 200 also includes a controller 300 electrically connected to the on-off valves 230 and 270, the flowmeters 251 to 253, the oxygen concentration sensor 280, and the vacuum pump 290. The on-off valves 230 and 270 and the vacuum pump 290 are controlled by the controller 300. Measured values by the flowmeters 251 to 253 and the oxygen concentration sensor 280 are input to the controller 300.

The fuel cell stack 100 to which the leakage inspection by the apparatus 200 is applied may have a complete cell stacked body 101, or may have a cell stacked body 101 in which only a part of the power generation cells 1 (for example, a single power generation cell 1) are stacked. When the leak inspection is performed on the fuel cell stack 100 having the complete cell stacked body 101, it can be quickly checked that none of the power generation cells 1 has the defect and that the entire fuel cell stack 100 does not have the defect. When the leak inspection is performed on only a part of the power generation cells 1 (for example, a single power generation cell 1), a defective power generation cell 1 to be replaced can be quickly identified. The leakage inspection may be performed on the fuel cell stack 100 having the cell stacked body 101 in which the power generation cell 1 whose soundness is checked in advance and the power generation cell 1 to be inspected are stacked in combination.

As the inspection gas supplied by the gas supply unit, a gas having higher permeability than air which is the oxidant gas is preferably used, and for example, a gas having a small molecular weight such as helium can be used. A supply pressure of the inspection gas to the anode flow path An is set in advance as a set pressure P1 of the regulator 241, and is set to a pressure (for example, 200 [kPa]) sufficiently higher than an atmospheric pressure P0 (P0<P1). A supply pressure of the inspection gas to the cathode flow path Ca is set in advance as a set pressure P2 of the regulator 242, and is set to a pressure (for example, 100 [kPa]) sufficiently lower than the set pressure P1 of the anode flow path An and sufficiently higher than the atmospheric pressure (P0<P2<P1). A supply pressure of the inspection gas to the cooling flow path Co is set in advance as a set pressure P3 of the regulator 243, and is set to a pressure (for example, 150 [kPa]) sufficiently lower than the set pressure P1 of the anode flow path An and sufficiently higher than the set pressure P2 of the cathode flow path Ca (P0<P2<P3<P1).

In the leak inspection, each of the flow paths An, Ca, and Co is sealed by closing the on-off valve 270 and closing the discharge line 260. In addition, the on-off valve 230 is opened and the supply lines 221 to 223 are opened, and thus, the inspection gases are continuously supplied. As a result, the pressures of the flow paths An, Ca, and Co are maintained at the set pressures P1 to P3. In such a state, flow rates VAn, VCa, and VCo of the inspection gases supplied to the flow paths An, Ca, and Co are measured by the flowmeters 251 to 253, and thus, the flow rates VAn, VCa, and VCo of the inspection gases flowing out from the flow paths An, Ca, and Co to the external space EX can be indirectly measured.

The controller 300 includes a computer including a CPU (processor), a RAM and a ROM (memories), an I/O interface, and other peripheral circuits. The controller 300 determines leakage states from the flow paths based on the flow rates VAn, VCa, and VCo (for example, a volume flow rate [mm3/min]) of the inspection gases flowing out from the flow paths An, Ca, and Co to the external space EX measured by the flowmeters 251 to 253.

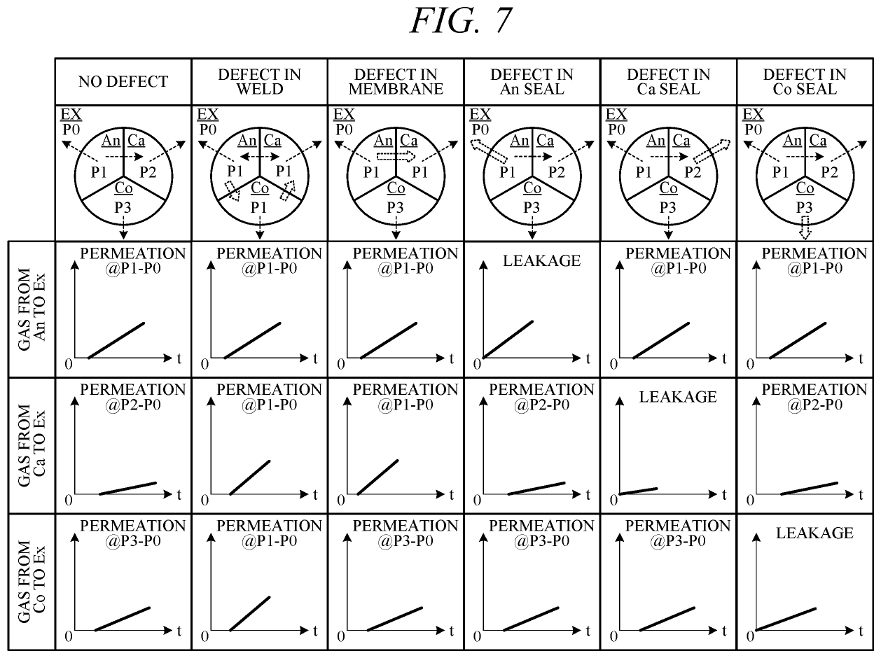

FIG. 7 is a diagram for describing the determination of the leakage states by the controller 300, and illustrates temporal changes of outflow amounts (for example, outflow volume [mm3]) of the inspection gases flowing out from the flow paths An, Ca, and Co to the external space EX after the supply of the inspection gases. The outflow amounts of the inspection gases can be calculated based on time-series flow rates VAn, VCa, and VCo measured at a predetermined cycle by the flowmeters 251 to 253 from a supply start point in time of the inspection gases to a present point in time.

As illustrated in FIG. 7, when there is a defect in the seal line 7 (periphery) that separates each of the flow paths An, Ca, and Co and the external space EX, the outflow amount is generated in a first period from immediately after the inspection gases of the set pressures P1 to P3 are supplied, in other words, until a predetermined time elapses after the inspection gases are supplied. On the other hand, when there is no defect in the seal line 7 (periphery) that separates each of the flow paths An, Ca, and Co and the external space EX, the outflow amount is not generated in the first period.

### <First Determination>

When it is determined that the flow rates VAn, VCa, and VCo measured by the flowmeters 251 to 253 in the first period exceed “0” and the outflow amount is generated, it can be determined that there is leakage from any of the flow paths An, Ca, and Co corresponding to any defective supply line of the supply lines 221 to 223 to the external space EX. In addition, it can be determined that there is a defect in the seal line 7 (periphery) that separates any defective flow path of the flow paths An, Ca, and Co determined to have leakage from the external space EX.

On the other hand, when it is determined that the flow rates VAn, VCa, and VCo measured by the flowmeters 251 to 253 in the first period are “0” and the outflow amount is not generated, it can be determined that there is no leakage from any of the flow paths An, Ca, and Co corresponding to any non-defective supply line of the supply lines 221 to 223 to the external space EX. In addition, it can be determined that there is no defect in the seal line 7 (periphery) that separates any non-defective flow path of the flow paths An, Ca, and Co determined to have no leakage from the external space EX.

When there is a defect in the electrode assembly 2 (on the periphery of the electrolyte membrane 22) or the separator 3 (welding line 8) that separates the flow paths An, Ca, and Co, the pressures of the flow paths Ca and Co to which the inspection gases are supplied increase at the relatively low set pressures P2 and P3. That is, when there is a defect in the electrode assembly 2 (on the periphery of the electrolyte membrane 22) that separates the anode flow path An and the cathode flow path Ca, the pressure of the cathode flow path Ca increases to the set pressure P1 of the anode flow path An with which the cathode flow path Ca communicates.

In addition, when there is a defect in the separator 3 (welding line 8) that separates the anode flow path An and the cathode flow path Ca from the cooling flow path Co, the cathode flow path Ca communicates with the anode flow path An and the cathode flow path Ca. In this case, first, the pressure of the cooling flow path Co increases to the set pressure P1 of the anode flow path An with which the cooling flow path Co communicates, and then the pressure of the cathode flow path Ca increases to the increased pressure P1 of the cooling flow path Co with which the cathode flow path Ca communicates.

In a case where there is no defect in the seal line 7 (periphery) that separates each of the flow paths An, Ca, and Co and the external space EX, the outflow amount is generated when a predetermined time elapses after the inspection gases of the set pressures P1 to P3 are supplied, in other words, in a second period after the first period. That is, in accordance with a differential pressure between the pressure of each of the flow paths An, Ca, and Co and the atmospheric pressure P0, the inspection gas permeates through the seal line 7 and flows out from each of the flow paths An, Ca, and Co to the external space EX. A relationship between each of the flow rates VAn, VCa, and VCo and the differential pressure when the inspection gas permeates through the seal line 7 is expressed by the following Equation (i).

$$flow rate [ mm 3 / min ] = differential pressure [ Pa ] \times permeability coefficient [ mm 2 / Pa \cdot min ] \times permeability area [ mm 2 ] / permeabilty width [ mm ] \qquad ( i )$$

In Equation (i), the permeability coefficient of the seal member constituting the seal line 7, and the permeability area and the permeability width of the seal line 7 that separates each of the flow paths An, Ca, and Co and the external space EX are known constants. Accordingly, based on Equation (i) and the flow rates VAn, VCa, and VCo measured by the flowmeters 251 to 253 in the second period, the differential pressure between the pressure of each of the flow paths An, Ca, and Co and the atmospheric pressure P0 can be calculated, and the pressure of each of the flow paths An, Ca, and Co can be calculated.

### <Second Determination>

When it is determined in the first determination that there is no defect in the seal line 7 (periphery), the second determination is performed. In the second determination, the pressure of the cathode flow path Ca is calculated based on the flow rate VCa measured by the flowmeter 252 in the second period, and it is determined whether or not the pressure of the cathode flow path Ca is maintained at the set pressure P2. When it is determined that the pressure of the cathode flow path Ca is not maintained at the set pressure P2, that is, the pressure increases to the set pressure P1 of the anode flow path An, it can be determined that there is leakage from the anode flow path An to the cathode flow path Ca. In this case, it can be determined that there is a defect in the electrode assembly 2 (on the periphery of the electrolyte membrane 22) or the separator 3 (welding line 8).

On the other hand, when it is determined that the pressure of the cathode flow path Ca is maintained at the set pressure P2, it can be determined that there is no leakage from the anode flow path An to the cathode flow path Ca. In this case, it can be determined that there is no defect in both the electrode assembly 2 (on the periphery of the electrolyte membrane 22) and the separator 3 (welding line 8).

### <Third Determination>

When it is determined in the second determination that there is a defect in the electrode assembly 2 (on the periphery of the electrolyte membrane 22) or the separator 3 (welding line 8), the third determination is performed. In the third determination, the pressure of the cooling flow path Co is calculated based on the flow rate VCo measured by the flowmeter 252 in the second period, and it is determined whether or not the pressure of the cooling flow path Co is maintained at the set pressure P3. When it is determined that the pressure of the cooling flow path Co is not maintained at the set pressure P3, that is, the pressure increases to the set pressure P1 of the anode flow path An, it can be determined that there is leakage from the anode flow path An to the cooling flow path Co. In this case, it can be determined that there is a defect in the separator 3 (welding line 8).

On the other hand, when it is determined that the pressure of the cooling flow path Co is maintained at the set pressure P3, it can be determined that there is no leakage from the anode flow path An to the cooling flow path Co. In this case, it can be determined that there is no defect in the separator 3 (welding line 8).

In the second determination and the third determination, in place of the calculation of the pressures of the cathode flow path Ca and the cooling flow path Co, the flow rates VAn, VCa, and VCo measured by the flowmeters 251 to 253 and the temporal changes of the outflow amounts of the inspection gases from the flow paths An, Ca, and Co to the external space EX may be compared. That is, since the permeability coefficient and the permeability width of the seal line 7 that separates each of the flow paths An, Ca, and Co and the external space EX are equal, and the permeability area is also substantially equal, outflow by permeation starts in order from a flow path having a high pressure. In addition, the higher the pressure of the flow path, the larger the flow rate.

In the second determination, it may be determined whether or not the outflows from the anode flow path An and the cathode flow path Ca start at the same time, and the flow rates VAn and VCa (increase rates of the outflow amounts in FIG. 7) are substantially the same based on the temporal changes of the flow rates VAn and VCa measured by the flowmeters 251 and 252 in the second period. When the outflows from the anode flow path An and the cathode flow path Ca start at the same time and it is determined that the flow rates VAn and VCa are substantially the same, it can be determined that the pressure of the cathode flow path Ca increases to the set pressure P1 of the anode flow path An. In this case, it can be determined that there is leakage from the anode flow path An to the cathode flow path Ca, and there is a defect in the electrode assembly 2 (on the periphery of the electrolyte membrane 22) or the separator 3 (the welding line 8).

On the other hand, when it is determined that the outflows from the anode flow path An and the cathode flow path Ca do not start at the same time and the flow rates VAn and VCa are not substantially the same, it can be determined that the pressure of the cathode flow path Ca is maintained at the set pressure P2. In this case, it can be determined that there is no leakage from the anode flow path An to the cathode flow path Ca, and there is no defect in both the electrode assembly 2 (on the periphery of the electrolyte membrane 22) and the separator 3 (welding line 8). Note that, when there is not defect in both the electrode assembly 2 (on the periphery of the electrolyte membrane 22) and the separator 3 (welding line 8) and there is no leakage between the flow paths, the pressures of the flow paths An, Ca, and Co are maintained at the set pressures P1 to P3. In this case, the anode flow path An, the cooling flow path Co, and the cathode flow path Ca of which the set pressures P1 to P3 (P1>P3>P2) are high start to flow out in this order, and the flow rates VAn, VCa, and VCo also increase in this order (VAn>VCo>VCa).

In the third determination, it may be determined whether or not the outflows from the flow paths An, Ca, and Co start at the same time and the flow rates VAn, VCa, and VCo are substantially the same based on the flow rates VAn, VCa, and VCo measured by the flowmeters 251 to 253 in the second period. When the outflows from the flow paths An, Ca, and Co start at the same time and it is determined that the flow rates VAn, VCa, and VCo are substantially the same, it can be determined that the pressures of the cathode flow path Ca and the cooling flow path Co increase to the set pressure P1 of the anode flow path An. In this case, it can be determined that there is leakage from the anode flow path An to the cooling flow path Co and from the cooling flow path Co to the cathode flow path Ca, and there is a defect in the separator 3 (welding line 8).

On the other hand, when it is determined that the outflows from the flow paths An, Ca, and Co do not start at the same time and the flow rates VAn, VCa, and VCo are not substantially the same, it can be determined that the pressure of the cooling flow path Co is maintained at the set pressure P3. In this case, it can be determined that there is no leakage from the anode flow path An to the cooling flow path Co, and there is no defect in the separator 3 (welding line 8). Note that, when there is no defect in the separator 3 (welding line 8) and there is no leakage from the anode flow path An to the cooling flow path Co and from the cooling flow path Co to the cathode flow path Ca, the pressure of the cooling flow path Co is maintained at the set pressure P3. In this case, after the outflows from the anode flow path An at the set pressure P1 and the cathode flow path Ca where the pressure is increased to the set pressure P1 of the anode flow path An start, the outflow of the set pressure P3 (P3<P1) from the cooling flow path Co starts. In addition, the flow rate VCo flowing out from the cooling flow path Co is smaller than the flow rates VAn and VCa flowing out from the anode flow path An and the cathode flow path Ca (VAn=VCa>VCo).

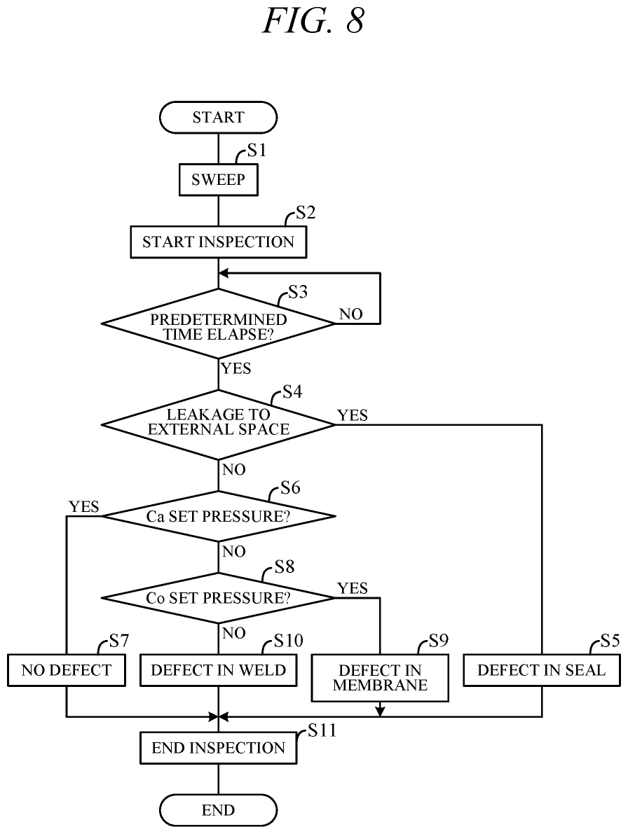

FIG. 8 is a flow chart illustrating an example of processing performed by the controller 300 of the apparatus 200. As illustrated in FIG. 8, first in S1 (S: processing step), each flow path An, Ca, and Co is swept by the inspection gas. In this case, the controller 300 controls to open the on-off valves 230 and 270 to open the supply lines 221 to 223 and the discharge line 260, controls to operate the vacuum pump 290, and waits until the oxygen concentration in the discharge line 260, as measured by the oxygen concentration sensor, becomes less than the specified concentration.

When the oxygen concentration becomes less than the specified concentration in S1, then in S2, the controller 300 controls to close the on-off valve 270 to close the discharge line 260 and seal each flow path An, Ca, and Co, controls to stop the vacuum pump 290, and starts the leak inspection. When each flow path An, Ca, and Co is sealed in S2, the pressure in each flow path An, Ca, and Co reaches the set pressure P1 to P3 of the corresponding regulators 241 to 243. Next in S3, the controller 300 determines whether the predetermined time elapses. S3 is repeated until the determination is positive in S3.

When the determination is positive in S3, then in S4, the controller 300 determines whether there is leakage from each flow path An, Ca, and Co to the external space EX based on the flow rates VAn, VCa, and VCo measured by the flowmeters 251 to 253 in the first period (first determination). When the determination is positive in S4, then in S5, the controller 300 determines that there is a defect in the seal lines 7 (periphery) and proceeds to S11.

When the determination is negative in S4, then in S6, the controller 300 determines whether the pressure of the cathode flow path Ca is maintained at the set pressure P2 based on the flow rates VAn, VCa, and VCo measured by the flowmeters 251 to 253 in the second period (second determination). When the determination is positive in S6, then in S7, the controller 300 determines that there is no defect in the seal lines 7 (periphery), the electrode assembly 2 (on the periphery of the electrolyte membrane 22), and the separator 3 (welding line 8), and proceeds to S11. When the determination is negative in S6, the controller 300 determines that there is a defect in the electrode assembly 2 (on the periphery of the electrolyte membrane 22) or the separator 3 (welding line 8), and proceeds to S8.

In S8, the controller 300 determines whether the pressure of the cooling flow path Co is maintained at the set pressure P3 based on the flow rates VAn, VCa, and VCo measured by the flowmeters 251 to 253 in the second period (third determination). When the determination is positive in S8, then in S9, the controller 300 determines that there is no defect in the seal lines 7 (periphery) and the separator 3 (welding line 8) and there is a defect in the electrode assembly 2 (on the periphery of the electrolyte membrane 22), and proceeds to S11. When the determination is negative in S8, then in S10, the controller 300 determines that there is no defect in the seal lines 7 (periphery) and the electrode assembly 2 (on the periphery of the electrolyte membrane 22) and there is a defect in the separator 3 (welding line 8), and proceeds to S11.

In S11, the controller 300 controls to close the on-off valve 230 to close the supply lines 221 to 223 to stop supply of the inspection gas, and controls to open the on-off valve 270 to open the discharge line 260 and open each flow path An, Ca, and Co to the outside air, and ends the leak inspection.

Thus, by supplying the inspection gas into multiple flow paths An, Ca, and Co simultaneously at different set pressures P1 to P3 and monitoring the flow rates VAn, VCa, and VCo flowing out of each flow path An, Ca, and Co, it becomes possible to efficiently inspect leakage states of the fuel cell stack 100 and the power generation cell 1. Specifically, since it becomes possible to simultaneously inspect the leakage state from each flow path An, Ca, Co to external space EX (S4, S5, S7) and the leakage state between the flow paths (S6 to S10) in one leakage inspection, it becomes possible to reduce time required for the leak inspection of the entire fuel cell stack 100 and power generation cell 1 and reduce consumption of inspection gas.

According to the present embodiment, the following functions and effects can be achieved.

(1) The apparatus 200 is configured to inspect the leakage state of the fuel cell stack 100 or the power generation cell 1 including the anode flow path An, the cathode flow path Ca, and the cooling flow path Co. The anode flow path An, the cathode flow path Ca, and the cooling flow path Co are separated from the external space EX through the seal line 7 respectively. The anode flow path An and the cathode flow path Ca are separated from each other through the electrode assembly 2 including the electrolyte membrane 22. The cooling flow path Co is separated from each of the anode flow path An and the cathode flow path Ca through the separator 3 including the welding line 8 (FIG. 5).

The apparatus 200 includes the gas supply unit (inspection gas tank 210 and regulators 241 to 243) that supplies the inspection gases to the anode flow path An at the set pressure P1, to the cathode flow path Ca at the set pressure P2 (P2<P1), and to the cooling flow path Co at the set pressure P3 (P2<P3<P1), the flowmeters 251 to 253 that measure the flow rates of the inspection gases flowing out from the anode flow path An, the cathode flow path Ca, and the cooling flow path Co, and the controller 300 (FIG. 6).

The controller 300 is configured to execute first determination step S4 of determining whether or not there is leakage of the inspection gases from the anode flow path An, the cathode flow path Ca, and the cooling flow path Co to the external space EX based on the flow rates measured by the flowmeters 251 to 253 in the first period until a predetermined time elapses after the supply of the inspection gases, second determination step S6 of determining whether or not there is leakage of the inspection gas from the anode flow path An to the cathode flow path Ca based on the flow rates measured by the flowmeters 251 to 253 in the second period after the predetermined time elapses after the supply of the inspection gases, and third determination step S8 of determining whether or not there is leakage of the inspection gas from the anode flow path An to the cooling flow path Co based on the flow rates measured by the flowmeters 251 to 253 in the second period (FIG. 8).

In first determination step S4, when it is determined that there is leakage of the inspection gas into the external space EX in the first period, it is determined that there is a defect in the seal line 7 (periphery) (S5). On the other hand, when it is determined that there is no leakage of the inspection gas into the external space EX in the first period, it is determined that there is no defect in the seal line 7 (periphery) (S7).

In second determination step S6, when it is determined that there is leakage of the inspection gas from the anode flow path An to the cathode flow path Ca in the second period, it is determined that there is a defect in the electrode assembly 2 (on the periphery of electrolyte membrane 22) or separator 3 (welding line 8) (S9 and S10). On the other hand, when it is determined that there is no leakage of the inspection gas from the anode flow path An to the cathode flow path Ca in the second period, it is determined that there is no defect in the electrode assembly 2 (on the periphery of the electrolyte membrane 22) and the separator 3 (welding line 8) (S7).

In third determination step S8, when it is determined that there is leakage of the inspection gas from the anode flow path An to the cooling flow path Co in the second period, it is determined that there is a defect in the separator 3 (welding line 8) (S10). On the other hand, when it is determined that there is no leakage of the inspection gas from the anode flow path An to the cooling flow path Co in the second period, it is determined that there is no defect in the separator 3 (welding line 8), and it is determined that there is a defect in the electrode assembly 2 (on the periphery of the electrolyte membrane 22) (S9).

In this manner, the inspection gases are simultaneously supplied to the plurality of flow paths and monitoring the flow rates flowing out from the flow paths, and thus, the leakage state of the product having the plurality of flow paths such as fuel cell stack 100 or power generation cell 1 can be efficiently inspected. In addition, the inspection gases are supplied to the plurality of flow paths at the different set pressures, and thus, the leakage state from each flow path to the external space and the leakage state between the flow paths can be simultaneously inspected. Accordingly, a time required for leak inspection of the entire product can be shortened, and the consumption of the inspection gas can be reduced.

(2) The apparatus 200 further includes the on-off valve 270 that seals the anode flow path An, the cathode flow path Ca, and the cooling flow path Co (FIG. 6). The flowmeters 251 to 253 measure the flow rates of the inspection gases flowing out from the anode flow path An, the cathode flow path Ca, and the cooling flow path Co by measuring the flow rates of the inspection gases supplied from the gas supply unit to each of the anode flow path An, the cathode flow path Ca, and the cooling flow path Co. Accordingly, the flow rates flowing out from the flow paths can be accurately measured with a simple configuration.

In the above embodiment, although it has been described that the leak inspection of the fuel cell stack 100 or the power generation cell 1 is performed, the product having the plurality of flow paths is not limited to such a product, and may be, for example, an electrolysis device, an electrochemical reaction device, or other products.

In the above embodiment, although it has been described that the leak inspection is performed on the fuel cell stack 100 or the power generation cell 1 having the three flow paths of the anode flow path An, the cathode flow path Ca, and the cooling flow path Co, the number of flow paths is not limited to three, and may be two or four or more.

In the above, the present invention has been described as the leakage inspection apparatus, however the present invention can also be applied as a leak inspection method configured to inspect the leakage state of the fuel cell stack 100 or the power generation cell 1 including the anode flow path An, the cathode flow path Ca, and the cooling flow path Co. The anode flow path An, the cathode flow path Ca, and the cooling flow path Co are separated from the external space EX through the seal line 7 respectively. The anode flow path An and the cathode flow path Ca are separated from each other through the electrode assembly 2 including the electrolyte membrane 22. The cooling flow path Co is separated from each of the anode flow path An and the cathode flow path Ca through the separator 3 including the welding line 8.

The leak inspection method includes the steps of: supplying inspection gas to the anode flow path An at the set pressure P1, to the cathode flow path Ca at the set pressure P2 (P2<P1), and to the cooling flow path Co at the set pressure P3 (P2<P3<P1); measuring the flow rates of the inspection gas flowing out from each of the anode flow path An, the cathode flow path Ca, and the cooling flow path Co; performing the first determination to determine whether there is leakage of the inspection gas from each of the anode flow path An, the cathode flow path Ca, and the cooling flow path Co to the external space EX based on the flow rates measured in the first period until a predetermined time elapses after supply of the inspection gas (S4); performing the second determination to determine whether there is leakage of the inspection gas from the anode flow path An to the cathode flow path Ca based on the flow rates measured in the second period after the predetermined time elapses after supply of the inspection gas (S6); and performing the third determination to determine whether there is leakage of the inspection gas from the anode flow path An to the cooling flow path Co based on the flow rates measured in the second period (S8) (FIG. 8).

In the first determination, it is determined that there is a defect in the seal line 7 (periphery) when it is determined that there is leakage of the inspection gas to the external space EX in the first period (S5). While, it is determined that there is no defect in the seal line 7 (periphery) when it is determined that there is no leakage of the inspection gas to the external space EX in the first period (S7).

In the second determination, it is determined that there is a defect in the electrode assembly 2 (on the periphery of electrolyte membrane 22) or separator 3 (welding line 8) when it is determined that there is leakage of the inspection gas from the anode flow path An to the cathode flow path Ca in the second period (S9 and S10). While, it is determined that there is no defect in the electrode assembly 2 (on the periphery of the electrolyte membrane 22) and the separator 3 (welding line 8) when it is determined that there is no leakage of the inspection gas from the anode flow path An to the cathode flow path Ca in the second period (S7).

In third determination, it is determined that there is a defect in the separator 3 (welding line 8) when it is determined that there is leakage of the inspection gas from the anode flow path An to the cooling flow path Co in the second period (S10). While, it is determined that there is no defect in the separator 3 (welding line 8) and it is determined that there is a defect in the electrode assembly 2 (on the periphery of the electrolyte membrane 22) when it is determined that there is no leakage of the inspection gas from the anode flow path An to the cooling flow path Co in the second period (S9).

The above embodiment can be combined as desired with one or more of the aforesaid modifications. The modifications can also be combined with one another.

According to the present invention, it becomes possible to efficiently inspect leakage state of a product having a plurality of flow paths.

Above, while the present invention has been described with reference to the preferred embodiments thereof, it will be understood, by those skilled in the art, that various changes and modifications may be made thereto without departing from the scope of the appended claims.

1. A leak inspection apparatus configured to inspect a leakage state of a product including a first flow path and a second flow path, the first flow path and the second flow path being separated from an external space through a first intermediate member respectively and being separated from each other through a second intermediate member, the leak inspection apparatus comprising:
a gas supply unit configured to supply inspection gas to the first flow path at a first pressure and supply the inspection gas to the second flow path at a second pressure lower than the first pressure;
flowmeters configured to measure flow rates of the inspection gas flowing out from each of the first flow path and the second flow path; and
a computer including a processor and a memory coupled to the processor, wherein
the computer:
performs a first determination to determine whether there is leakage of the inspection gas from each of the first flow path and the second flow path to the external space based on the flow rates measured by the flowmeters in a first period after supply of the inspection gas; and
performs a second determination to determine whether there is leakage of the inspection gas from the first flow path to the second flow path based on the flow rates measured by the flowmeters in a second period after the first period, wherein
in the first determination, the computer determines that there is a defect in the first intermediate member when it is determined that there is leakage of the inspection gas to the external space in the first period, while determines that there is no defect in the first intermediate member when it is determined that there is no leakage of the inspection gas to the external space in the first period, wherein
in the second determination, the computer determines that there is a defect in the second intermediate member when it is determined that there is leakage of the inspection gas from the first flow path to the second flow path in the second period, while determines that there is no defect in the second intermediate member when it is determined that there is no leakage of the inspection gas from the first flow path to the second flow path in the second period.

2. The leak inspection apparatus according to claim 1, wherein
a permeability coefficient of the first intermediate member is different from a permeability coefficient of the second intermediate member.

3. The leak inspection apparatus according to claim 1, wherein
the product is one of a fuel cell stack and a power generation cell, wherein
each of the first flow path and the second flow path is one of an anode flow path through which fuel gas flows, a cathode flow path through which oxidant gas flows, and cooling flow path through which cooling medium flows, wherein
the second intermediate member is one of: a gas permeable member separating the anode flow path from the cathode flow path; and a gas-impermeable member separating the anode flow path and the cathode flow path from the cooling flow path.

4. The leak inspection apparatus according to claim 1, further comprising:
a valve configured to seal each of the first flow path and the second flow path, wherein
the flowmeters measure the flow rates of the inspection gas flowing out from each of the first flow path and the second flow path by measuring the flow rates of the inspection gas supplied from the gas supply unit to each of the first flow path and the second flow path.

5. The leak inspection apparatus according to claim 1, wherein
the first period is a period during which the flow rates measured by the flowmeters are zero when there is no defect in the first intermediate member.

6. The leak inspection apparatus according to claim 1, wherein
the computer performs the second determination when it is determined in the first determination that there is no defect in the first intermediate member.

7. The leak inspection apparatus according to claim 1, wherein
the second pressure is set higher than a pressure of the external space.

8. A leak inspection method configured to inspect a leakage state of a product including a first flow path and a second flow path, the first flow path and the second flow path being separated from an external space through a first intermediate member respectively and being separated from each other through a second intermediate member, the leak inspection method comprising the steps of:
supplying inspection gas to the first flow path at a first pressure and supply the inspection gas to the second flow path at a second pressure lower than the first pressure;
measuring flow rates of the inspection gas flowing out from each of the first flow path and the second flow path;
performing a first determination to determine whether there is leakage of the inspection gas from each of the first flow path and the second flow path to the external space based on the flow rates measured in a first period after supply of the inspection gas; and
performing a second determination to determine whether there is leakage of the inspection gas from the first flow path to the second flow path based on the flow rates measured in a second period after the first period, wherein
in the first determination, it is determined that there is a defect in the first intermediate member when it is determined that there is leakage of the inspection gas to the external space in the first period, while it is determined that there is no defect in the first intermediate member when it is determined that there is no leakage of the inspection gas to the external space in the first period, wherein
in the second determination, it is determined that there is a defect in the second intermediate member when it is determined that there is leakage of the inspection gas from the first flow path to the second flow path in the second period, while it is determined that there is no defect in the second intermediate member when it is determined that there is no leakage of the inspection gas from the first flow path to the second flow path in the second period.

9. The leak inspection method according to claim 8, further comprising the steps of:
sealing each of the first flow path and the second flow path, wherein
the measuring includes measuring the flow rates of the inspection gas flowing out from each of the first flow path and the second flow path by measuring the flow rates of the inspection gas supplied to each of the first flow path and the second flow path.
